(19) United States
(12) Patent Application Publication
(10) Pub. No.: US 2022/0236193 A1
(43) Pub. Date: Jul. 28, 2022

(54) METHOD AND DEVICE FOR OPTICALLY INSPECTING CONTAINERS

(71) Applicant: KRONES AG, Neutraubling (DE)

(72) Inventor: Anton NIEDERMEIER, Offenstetten (DE)

(21) Appl. No.: 17/596,191

(22) PCT Filed: Mar. 4, 2020
(86) PCT No.: PCT/EP2020/055618

§ 371 Date: Dec. 3, 2021

(30) Foreign Application Priority Data
Jun. 6, 2019 (DE) 10 2019 208 296.3

(51) Int. Cl. G01N 21/90; G01N 21/88

(52) U.S. Cl. CPC G01N 21/90; G01N 2021/8848; G01N 21/8851

(57) ABSTRACT

The invention relates to a method for optically inspecting containers, wherein an illumination unit emits light from a flat light-emitting surface and light transmitted or reflected by the containers is captured in at least one camera image. The camera image is analysed by an image processing unit for intensity information in order to identify foreign bodies and/or defects in the container. To this end, the light emitted from the light-emitting surface is locally encoded on the basis of at least one of a polarisation characteristic, an intensity characteristic and a phase characteristic and is captured in such a way that different emission locations on the light-emitting surface can be differentiated from one another in the camera image. The image processing unit analyses the camera image for location information of the emission locations, in order to differentiate the defects from the foreign bodies.

### TECHNICAL FIELD

The disclosure relates to a method and a device for optically inspecting containers.

### BACKGROUND AND SUMMARY

Typically, such methods and devices are employed to inspect the containers for foreign bodies and/or defects. To this end, the containers are transported to an inspection unit with an illumination unit and with a camera, so that they can be inspected by transmitted light or incident light. In the process, the illumination unit emits light from a flat light-emitting surface, wherein the light is transmitted or reflected via the containers and subsequently captured with the camera as at least one camera image. Subsequently, the at least one camera image is analyzed by an image processing unit for intensity information in order to identify the foreign bodies and/or defects of the containers.

For example, such methods and devices are employed in sidewall, bottom and/or filling level inspection of empty containers or containers already filled with a product.

Here, the containers are typically inspected with a diffusely emitting light-emitting surface to identify foreign bodies in order to suppress glass imprints or drops of water in the camera image, for example. The foreign bodies can be, for example, soiling, product residues, residues of labels, or the like.

In contrast, in order to identify defects, a light-emitting surface emitting in a directed manner is employed to amplify the refraction of light in the camera image occurring thereby. The defects can be, for example, damages at the containers, for example chipped glass. It is also conceivable that these are defectively produced material points, such as, for example, local material bulges.

Consequently, two different inspection units with different emission characteristics of the illumination units are typically employed in order to be able to identify foreign bodies and defects equally easily.

It is here a disadvantage that this requires corresponding efforts and installation space for the optical inspection of the containers.

From US 2013/0215261 A1, a method for identifying defects in glass articles and a device suited for this are known. To increase the contrast, illumination with a plurality of light patterns shifted with respect to each other is suggested therein.

DE 10 2014 220 598 A1 discloses an inspection device for a transmitted light inspection of containers with an apparatus for dividing the light-emitting surface into at least two mainly horizontally separated partial areas which can be selectively switched on and off for a sidewall inspection and/or closing head inspection of the container.

U.S. Pat. No. 6,304,323 B1 discloses a method for identifying defects in bottles.

EP 0 472 881 A2 discloses a system and a method for optically inspecting the bottom surfaces of transparent containers.

US 2008/0310701 A1 discloses a method and a device for visually inspecting an object.

EP 0 926 486 B1 discloses a method for optically inspecting transparent containers using infrared and polarized visible light.

DE 10 2017 008 406 A1 discloses an inspection device with a colored illumination for inspecting containers for impurities and three-dimensional container structures. To this end, a radiation source includes a plurality of spatially separated radiation zones that emit radiation in different wavelength ranges or with different intensities. In decorative elements, a local color contrast appears in this way, while in impurities, only a local brightness contrast, and no local color contrast, appears. However, in rare cases, the defects might nevertheless not be able to be differentiated from the foreign bodies in colored containers.

It is the object of the present disclosure to provide a method and a device for optically inspecting containers by which both foreign bodies and defects can be identified with only a few efforts and which require a smaller installation space.

To achieve this object, the disclosure provides a method for optically inspecting containers.

In extensive examinations by the applicant, it was found that light is refracted at the defects in a different way than at undamaged regions of the containers due to the local modification of the container surface in connection with defects. Consequently, the light is deflected via the defect towards the camera from a different emission location of the light-emitting surface than from the undamaged regions. Vice versa, this is often not the case, or not as often the case, with foreign bodies since, for example, soiling leads to a local absorption of the light without essentially influencing the light path towards the camera in the process.

By the light emitted from the light-emission surface being locally encoded on the basis of the polarization characteristic, the intensity characteristic, and/or the phase characteristic and being captured by the camera, independent of the emission characteristic of the light-emitting surface, it can be determined for the image points of the camera image each from which one of the emission locations the corresponding light proportion originates. By the image processing unit analyzing the at least one camera image for location information of the emission locations, a differentiation can be made between a defect and a foreign body, for example, due to a local modification of the emission location. Vice versa, the intensity information can still be analyzed to be able to identify the absorption of the light by foreign bodies particularly well with a diffuse emission characteristic of the light-emitting surface. Consequently, with the method according to the disclosure, it is possible to identify equally well both foreign bodies and defects with one single inspection unit. By this being done with one single inspection unit, a smaller installation space is required for this.

The method for the optical inspection can be employed in a beverage processing plant. The method can be upstream or downstream of a container manufacturing method, cleaning method, filling and/or closing method. The method can be employed in a full-bottle or empty-bottle inspection machine. For example, the method can be employed for inspecting returned reusable containers.

The containers can be provided for receiving beverages, foodstuff, sanitary products, pastes, chemical, biological and/or pharmaceutical products. The containers can be embodied as bottles, in particular as plastic bottles or glass bottles. Plastic bottles can specifically be PET, PEN, HD-PE or PP bottles. They can equally be biodegradable containers or bottles whose main components consist of renewable resources, such as, for example, sugar cane, wheat or sweetcorn. The containers can be provided with a cap, for example with a crown cap, screw cap, tear-off cap or the like. Equally, the containers can be present as empties, for example, without any cap.

It is conceivable that the method is employed for the sidewall, bottom, opening and/or contents control of the containers. The foreign bodies can be soiling, product residues, residues of labels, and/or the like. The defects can be, for example, damages at the containers, for example chipped glass. It is also conceivable that they are defectively produced material points, such as, for example, local material bulges or tapers.

The containers can be transported to the inspection unit as a container flow with a transporter. The transporter can comprise a carousel and/or a linear transporter. It is, for example, conceivable for the transporter to comprise a conveyor belt on which the containers are transported in an upright position into a region between the illumination unit and the camera. Receptacles holding one or several containers during transport are conceivable (PUK). The container can also be transported held by lateral belts if e. g. the illumination transmits light through the container bottom and the camera inspects the bottom through the container opening.

The illumination unit can generate the light with at least one light source, for example a light bulb, a fluorescent tube or with at least one LED. In some embodiments, the light can be generated with a matrix of LEDs and emitted towards the light-emitting surface. The light-emitting surface can be larger than the camera view of the container. It is also conceivable that the light-emitting surface only illuminates a portion of the camera view of the container. The light-emitting surface can emit the light partially or completely diffusely. In an embodiment, the light-emitting surface can comprise a diffusing screen by which the light is flatly and diffusely dispersed from the at least one light source towards the camera. An emission location can here mean a location point or a flat section of the light-emitting surface. It is conceivable that the emission locations of the light-emitting surface continuously pass into one another, so that the polarization characteristic, the intensity characteristic, and/or the phase characteristic continuously change(s) over the light-emitting surface.

The camera can capture the at least one of the containers and the light transmitted or reflected via it with a lens and an image sensor. The image sensor can be, for example, a CMOS or a CCD sensor. It is conceivable that the camera transmits the at least one camera image to the image processing unit with a data interface. It is conceivable that the light is generated by the illumination unit, is subsequently transmitted through the containers and then captured by the camera. The camera can separate, for each image point of the at least one camera image, the polarization characteristic, the intensity characteristic, and/or the phase characteristic of the captured transmitted or reflected light.

The image processing unit can process the at least one camera image with a signal processor and/or with a CPU and/or GPU. It is also conceivable that the image processing unit to this end comprises a storage unit, one or more data interfaces, for example a network interface, a display unit, and/or an input unit. It is conceivable that the image processing unit analyzes the at least one camera image with image processing algorithms present in the storage unit as a computer program product.

“That the light emitted from the light-emitting surface is locally encoded on the basis of a polarization characteristic, an intensity characteristic, and/or a phase characteristic and is captured by the camera such that in the at least one camera image, different emission locations of the light-emitting surface can be differentiated from each other” can here mean that the light is emitted from the light-emitting surface with the polarization characteristic, the intensity characteristic, and/or the phase characteristic in a locally varying manner, so that the different emission locations with the polarization characteristic, the intensity characteristic, and/or the phase characteristic are each encoded differently, wherein the camera captures, in the at least one camera image, the polarization characteristic, the intensity characteristic, and/or the phase characteristic as the location information.

It is conceivable that the local encoding of the emitted light is adapted to a task, in particular a container type, on the basis of the polarization characteristic, the intensity characteristic, and/or the phase characteristic. For example, borders of the locally encoded light can be adapted to a container height and/or width to this end. In other words, the region of the light-emitting surface, which varies with the polarization characteristic, the intensity characteristic, and/or the phase characteristic, can be variably enlarged or reduced.

The light emitted from the light-emitting surface can be emitted in the visible range and/or non-visible range of the wavelength spectrum. For example, the light in the visible range may be perceivable for the human eye, and/or be within a wavelength range of 380 nm-750 nm. The non-visible range may not be perceivable for the human eye, and/or be in the UV or IR wavelength range. It is also conceivable that the visible range is combined with the non-visible range. For example, with containers of brown glass, the light could be emitted the light-emitting surface with red and infrared optical wavelengths.

The polarization characteristic can here mean that the light is emitted from the different emission locations of the light-emitting surface with different polarization directions each. For example, in the region of the light-emitting surface, a polarization filter with a continuously changing polarization progress, or a plurality of polarization filters with different orientations can be arranged, so that the polarization of the emitted light changes locally. It is conceivable that the camera separates the polarization characteristic in the at least one camera image. To this end, it can comprise, for example, a plurality of image sensors with one differently oriented polarization filter each, or a single image sensor with a polarization filter matrix. In particular, the camera can comprise a Sony IMX250MZR sensor. Polarization characteristic can here mean a linear, elliptic, and/or circular polarization characteristic.

It is conceivable that the image processing unit analyzes the at least one camera image for location information of the emission locations to additionally identify local material imprints, for example embossings, glass imprints, pearls and the like, at the containers and/or differentiate them from the foreign bodies. Such material imprints can be employed, for example, as decorative elements. The image processing unit can analyze the at least one camera image for intensity information and location information of the emission locations to identify regions with changed location information and changed intensity information as the container edge. Since at the container edge, both an obscuration and a particularly distinct deflection of the light beams is effected, the container edge can thus be identified particularly easily. For example, by the image processing unit analyzing the at least one camera image for a third local region with deviating intensity information with respect to the surrounding area and deviating location information to conclude that the container edge is present.

It is also conceivable that the light emitted from the light-emitting surface is locally encoded with a wavelength characteristic, in addition to the polarization characteristic, the intensity characteristic, and/or the phase characteristic. Thereby, the emitted light can be locally encoded both with the wavelength and with the polarization, for example. The camera can then separate both the wavelength characteristic and the polarization characteristic in the at least one camera image. For example, the camera can comprise a Sony IMX250MYR sensor to this end.

Intensity characteristic can here mean that the light is emitted from the different emission locations of the light-emitting surface with different intensities or intensity progresses each. Phase characteristic of the emitted light can here mean that a periodic intensity progress, in particular a sinusoidal intensity progress, is modulated on the emitted light, wherein the phase of the periodic intensity progress is different for the different emission locations.

The image processing unit can analyze the at least one camera image for a first local region with intensity information deviating from a surrounding area to conclude that a foreign body is present. By defects typically absorbing light, it can be identified in the at least one camera image particularly easily via the deviating intensity information.

The image processing unit can analyze the at least one camera image for a second local region with location information deviating from a surrounding area to conclude that a defect is present. By the defect of the container deflecting the light differently from surrounding regions of the defect, it can be identified in the at least one camera image particularly easily in this manner. For example, the defect can have polarization information in the at least one camera image that are different from those of the surrounding area. By this, one can then conclude that the refraction of light is different with respect to the surrounding area, and thus a defect is present.

The at least one camera image may be separated, with the image processing unit, into an intensity channel and a light characteristic channel for the polarization characteristic, the intensity characteristic, and/or the phase characteristic, wherein the image processing unit identifies the foreign bodies on the basis of the intensity channel, and the defects on the basis of the light characteristic channel. Thereby, the foreign bodies and the defects can be analyzed particularly easily in both channels separately. The intensity channel can here mean a channel for a relative brightness, an absolute brightness, or for an intensity.

It is conceivable that the light is emitted from the emission locations of the light-emitting surface each with a temporally different intensity progress to encode the different emission locations as the intensity characteristic and/or the phase characteristic. Thereby, containers with different color transparencies can be inspected in a particularly reliable manner. It is conceivable that here, the phase characteristic comprises a time offset of the intensity progress different for each of the different emission locations. “Time offset” could here mean an offset with respect to a reference signal. In other words, the intensity progress could comprise an intensity sequence or a sinusoidal intensity progress, the time offset of the intensity progress being selected differently each at the different emission locations with respect to a reference signal. It is conceivable that the camera captures transit time differences of the light transmitted or reflected into the containers to determine the phase characteristic. For example, cameras are known for this which capture the transit time, or respectively the phase offset with respect to the reference signal, of the light for each image point.

In addition or as an alternative, it is conceivable that the intensity characteristic comprises time sequences of light intensities of the intensity progress each different for the different emission locations. For example, for the different emission locations, one different intensity sequence of the emitted light each could be selected. Intensity sequence can here mean, for example, a sequence of several temporally consecutive time sections, wherein in one time section each, the light is emitted brightly or darkly.

Moreover, to achieve the object, the disclosure provides a device for optically inspecting containers.

By the illumination unit being embodied to emit the light emitted from the light-emission surface locally encoded on the basis of the polarization characteristic, the intensity characteristic, and/or the phase characteristic, and by the camera being embodied to capture the locally encoded light, independent of the emission characteristic of the light-emitting surface, it can be determined for the image points of the camera image each from which one of the emission locations the corresponding light proportion originates. By the image processing unit being embodied to analyze the at least one camera image for location information of the emission locations, a differentiation can be made, for example, between a defect and a foreign body due to a local modification of the emission location. Vice versa, the intensity information can still be analyzed to be able to identify the absorption of the light by foreign bodies particularly well with a diffuse emission characteristic. Consequently, with the device according to the disclosure, it is possible to identify foreign bodies and defects equally well with one single inspection unit. By this being done with one single inspection unit, a smaller installation space is required for this.

The device for optically inspecting containers can be embodied for carrying out the method. The device can analogously comprise the above-described features.

The device for the optical inspection can be arranged within a beverage processing plant. The beverage processing plant can comprise container handling machines, in particular a container manufacturing machine, a rinser, a filler, a closer, a labelling machine, a direct printing machine, and/or a packaging machine. It is conceivable that the device is associated with one of the mentioned container handling machines for inspection. The device can here be employed for full bottle or empty bottle inspection. It is conceivable, for example, that the device is employed for inspecting returned reusable containers.

The illumination unit can be embodied to emit the light locally differently with the polarization characteristic, the intensity characteristic, and/or the phase characteristic. For example, in the region of the light-emitting surface, a polarization filter with a continuously changing polarization progress, or a plurality of polarization filters with different orientations, may be arranged, so that the polarization of the emitted light changes locally.

It is conceivable that the illumination unit is embodied to emit light from the emission locations of the light-emitting surface each with a temporally different intensity progress to encode the different emission locations as the intensity characteristic and/or the phase characteristic. Thereby, differently colored containers can be inspected particularly reliably.

The camera can be embodied to capture the polarization characteristic, the intensity characteristic, and/or the phase characteristic in a spatially resolved manner. This can be done, for example, as described above with respect to the method, via polarization filters, in particular via a polarization filter matrix. The camera can be embodied as a polarization camera and/or as a transit-time camera. Thereby, the wavelength characteristic, the polarization characteristic, the intensity characteristic, and/or the phase characteristic can be captured with few efforts in a spatially resolved manner. In particular, the camera can comprise a Sony IMX250MZR or IMX 250MYR sensor.

### BRIEF DESCRIPTION OF THE FIGURES

Further features of the disclosure will be illustrated below more in detail with reference to the exemplified embodiments represented in the figures. In the figures:

FIG. 1 shows an exemplified embodiment according to the disclosure of a method for optically inspecting containers as a flow chart;

FIG. 2 shows an exemplified embodiment according to the disclosure of a device for optically inspecting containers as a perspective view;

FIG. 3 shows a detailed view of the light-emitting surface of the illumination unit of FIG. 2;

FIGS. 4A-4B show a lateral view of the light-emitting surface and the camera of FIGS. 2 and 3 during the inspection of a foreign body and a defect;

FIG. 5A shows the camera image during the inspection of the foreign body and the defect according to FIGS. 4A-4B on the basis of a polarization characteristic;

FIGS. 5B-5C show the intensity channel G and the light characteristic channel C of the camera image I of FIG. 5A; and

FIGS. 6A-6B show a detailed view of a further embodiment of the illumination unit of FIG. 2, wherein the light is emitted from the emission locations of the light-emitting surface each with a temporally different intensity progress.

### DETAILED DESCRIPTION

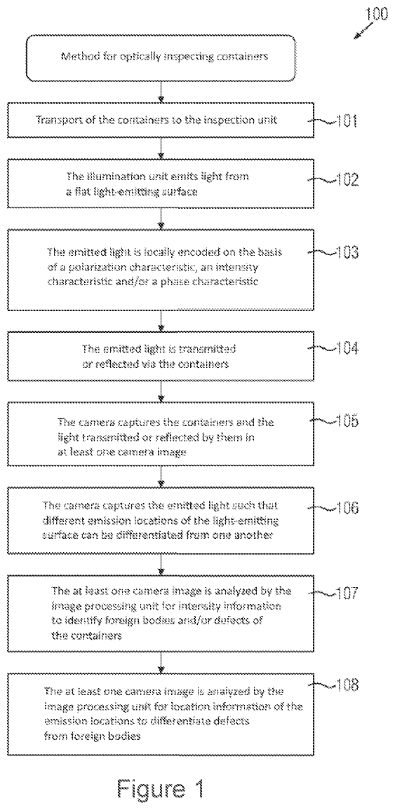

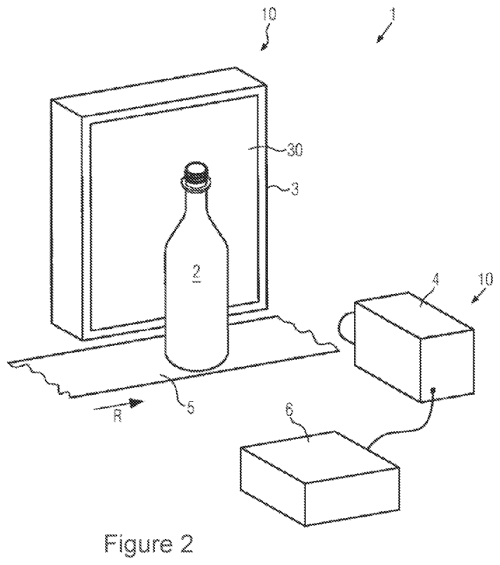

In FIG. 1, an exemplified embodiment according to the disclosure of a method 100 for inspecting containers 2 is represented as a flowchart. The method 100 will be illustrated more in detail with reference to FIGS. 2-6B:

In FIG. 2, an exemplified embodiment according to the disclosure of a device 1 for optically inspecting containers 2 is represented as a perspective view. One can see the inspection unit 10 with the illumination unit 3 and with the camera 4. Between them, the transporter 5 is arranged which is here, only by way of example, embodied as a conveyor belt on which the containers 2 are transported between the illumination unit 3 and the camera 4 in the direction R (Step 101). By way of example, only one single container 2 which is being inspected is represented. Nevertheless, the containers 2 are transported on the transporter 5 as a container flow and each optically inspected between the illumination unit 3 and the camera 4.

The illumination unit emits light from the flat light-emitting surface 30 to transmit light through the containers 2 (Step 102). The emitted light is transmitted via the containers 2 towards the camera 4 (Step 104). It is also conceivable that, by the arrangement of the illumination unit 3 opposite the camera 4, the light is reflected via the containers 2. The camera 4 is arranged at the inspection unit 10 such that it captures the containers 2 and light transmitted via them in at least one camera image (Step 105).

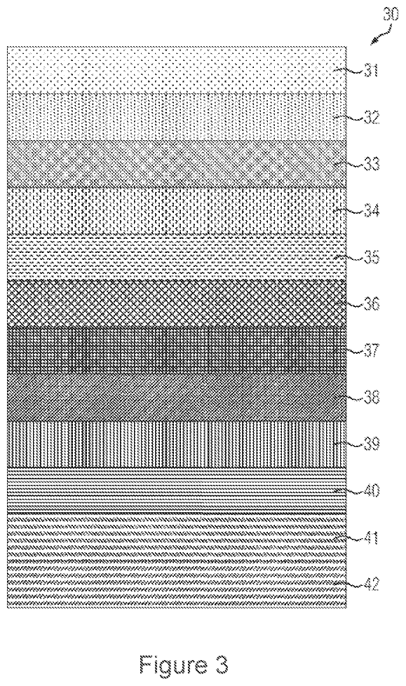

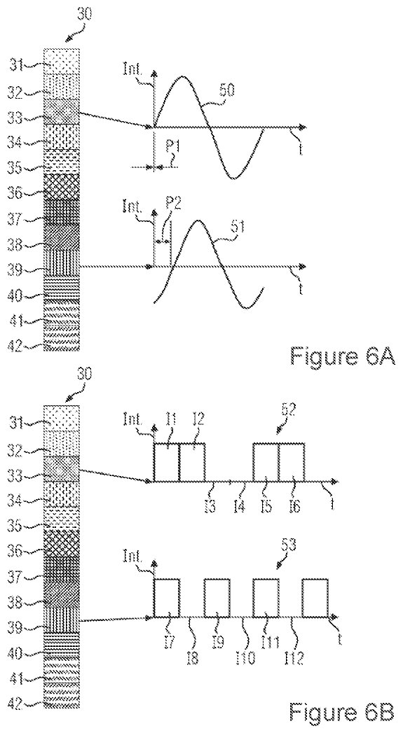

The illumination unit 3 can comprise, for example, a matrix of LEDs that emit light onto the light-emitting surface 30. For example, the light-emitting surface 30 can be embodied as a diffusing screen to emit the light of the LEDs in a diffuse manner. Moreover, the illumination unit 3 emits the light from the light-emitting surface 30 on the basis of the polarization characteristic, the intensity characteristic, and/or the phase characteristic in a locally encoded manner (Step 103). This will be illustrated more in detail below with reference to the exemplified embodiments in FIGS. 3 and 6A-6B. Correspondingly, the camera 4 is embodied to capture the locally encoded light, so that in the at least one camera image, different image locations of the light-emitting surface 30 can be differentiated from each other (Step 106).

Furthermore, the image processing unit 6 can be seen by which the at least one camera image is analyzed for intensity information in order to identify foreign bodies and/or defects of the containers (Step 107). This can be done, for example, with image processing algorithms for identifying local changes in the at least one camera image known per se.

Moreover, the image processing unit 6 analyzes the at least one camera image for location information of the emission locations in order to differentiate the defects from the foreign bodies (Step 108).

The method 100 and the device 1 will be illustrated more in detail below with reference to FIGS. 3-6B.

In FIG. 3, a detailed view of the light-emission surface 30 of FIG. 2 is represented. In detail, the different emission locations 31 to 42 of the light-emitting surface 30 can be seen which are locally encoded on the basis of the polarization characteristic, the intensity characteristic, and/or the phase characteristic.

For example, it is a polarization characteristic, so that the different emission locations 31 to 42 emit light each with different polarization directions. It is, for example, conceivable that the emission location 31 emits light with a polarization direction of 0°, the emission location 34 with 45°, the emission location 37 with 90°, and the emission location 40 with 135°. Correspondingly, the polarization directions of the emission locations 23, 33, 35, 36, 38, 39 are lying between them in an interpolated manner, or those of the emission locations 41 to 42 are extrapolated therefrom. The distribution of the polarization directions across the illumination surface is exemplary. It can also be embodied to be discontinuous, meaning with abrupt changes of the polarization direction or with repeating patterns of the polarization directions.

In order to capture the different emission locations 31 to 42 and store them as location information in the at least one camera image, the camera 4 is, in this embodiment, embodied as a polarization camera with a Sony IMX250MZR image sensor.

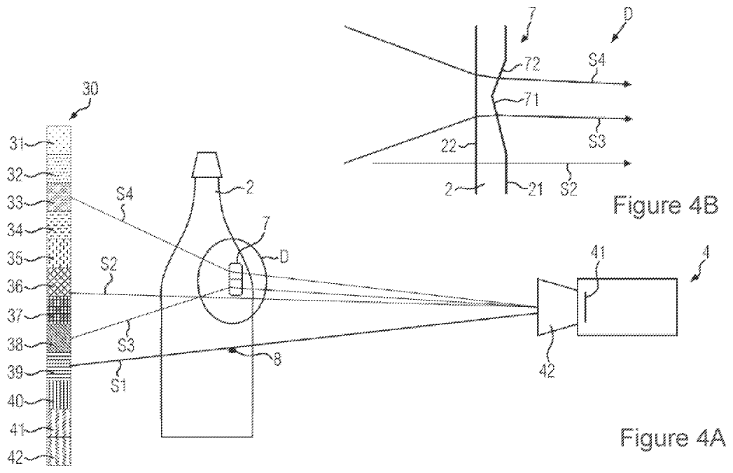

In FIGS. 4A-4B, a lateral view of the light-emitting surface 30 and the camera 4 of FIGS. 2 and 3 during the inspection of a foreign body 8 and a defect 7 is represented. In FIG. 4B, the detail D of FIG. 4A is shown.

One can see the flatly emitting light-emitting surface 30 with the different emission locations 31 to 42 in a lateral profile. From there, the light is flatly emitted towards the camera 4 and is thus transmitted through the container 2. The container 2 here consists, for example, of a transparent glass material, so that the light is transmitted through the container 2.

The camera 4 comprises the image sensor 41 and the lens 42 to capture the container 2 in at least one camera image. It is conceivable that the camera 4 is embodied as a polarization camera and/or transit-time camera.

One can furthermore see the light beam 51 which passes through the container 2 starting from the emission location 39. It impinges on the foreign body 8 which absorbs a portion of its energy. Consequently, the foreign body 8 appears with a reduced intensity compared to its direct surrounding area in the at least one camera image of the camera 4. By the foreign body not deflecting the light beam 51, it appears with the same polarization characteristic, intensity characteristic, and/or phase characteristic of the emission location 39 as its direct surrounding area in the at least one camera image.

Furthermore, one can see the light beam S2 which, starting from the location 36, passes through the container 2 in a surrounding area of the defect 7. Here, the light is only slightly absorbed, depending on the material of the container 2, so that the corresponding image point in the at least one camera image appears with a high intensity and the polarization characteristic, the intensity characteristic, and/or the phase characteristic of the emission location 36. As can moreover be seen in FIG. 4B, the light beam S2 passes through the container 2 at a point where the container's inner wall 22 and the container's outer wall 21 extend in a plane-parallel manner with respect to each other. Consequently, the light beam S2 undergoes only a slight offset, however, no change of direction, depending on the angle of impact. Consequently, the corresponding image point appears with a high intensity and the polarization characteristic, the intensity characteristic, and/or the phase characteristic of the emission location 36 in the at least one camera image.

In contrast, one can see in FIG. 4B that the defect 7 includes local notch surfaces 71, 72 at the container's outer wall 21. This can be, for example, a notch due to chipping. Consequently, the light beams S3, S4 are deflected at the local notch surfaces 71, 72 by refraction of light. More precisely, the light beam S3 is emitted from the emission location 38 and deflected, during its passage through the container 2, towards the camera 4 at the first notch surface 71 by refraction of light. In contrast, the light beam S4 passes through the container 2 starting from the emission location 33 and is deflected towards the camera 4 at the second notch surface 72 by refraction of light. Accordingly, the defect 7 appears, due to the local refraction of light, at the notch surfaces 71, 72 in the at least one camera image with a different polarization characteristic, intensity characteristic, and/or phase characteristic compared to the surrounding area.

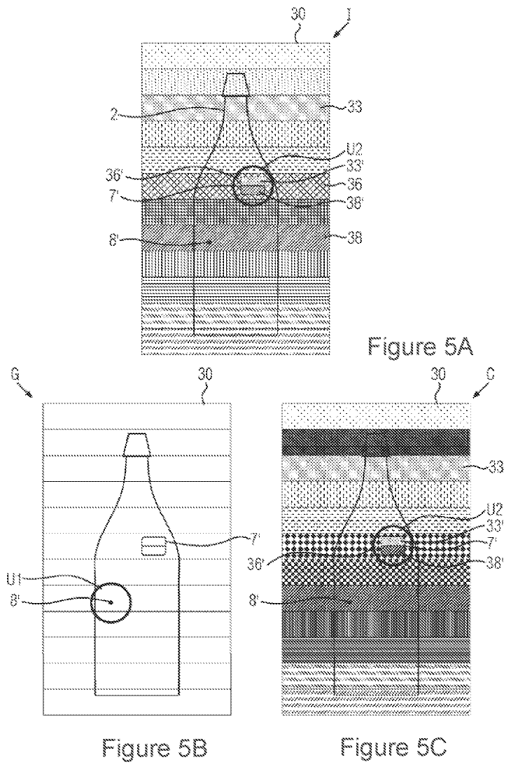

FIG. 5A is a camera image I represented more in detail during the inspection of the foreign body 8 and the defect 7 on the basis of the polarization characteristic.

One can see that the container 2 appears in front of the light-emitting surface 30 in the camera image I. One can furthermore see that the foreign body 8 is imaged as an obscured first local region 8′. In contrast, the defect 7 is imaged as a second local region 7′ with an intensity similar to that of the direct surrounding area, however, it there appears in the upper region with the location information 33′ of the emission location 33, and in the lower region with the location information 38′ of the emission location 38 since the beams are locally deflected by the defect 7 as is shown in FIG. 4A.

In FIGS. 5B-5C, the intensity channel G and the light characteristic channel C of the camera image I of FIG. 5A are represented. The light characteristic channel C is provided for the polarization characteristic, the intensity characteristic, and/or the phase characteristic.

The image processing unit 6 represented in FIG. 2 initially separates the camera image I represented in FIG. 5A into the intensity channel G and the light characteristic channel C. Since in this embodiment, the light-emitting surface emits the light on the basis of the polarization characteristic, and the camera 4 captures the polarization directions as location information, the light characteristic channel C is a polarization channel.

The image processing unit 6 subsequently analyzes the intensity channel G of the camera image I for the first local region 8′ with intensity information deviating from the surrounding area U1 to conclude that the foreign body 8 is present. For example, this is done by means of a filter for identifying brightness variations.

Furthermore, the image processing unit 6 analyzes the light characteristic channel C of the camera image I with the polarization for the second local region 7′ with location information deviating from the surrounding area U2. As can be seen in FIG. 5C, the local region 7′ of the defect 7 appears in the upper region with the location information 33′, and in the lower region with the location information 38′. In contrast, the direct surrounding area U2 includes the location information 36′ of the emission location 36. So, since the second local region 7′ has a different location information 33′, 38′ than its surrounding area U2, the defect 7 can be differentiated from the foreign body 8.

After the foreign body 8 and/or the defect 7 has been identified, the image processing unit 6 generates a signal that the container 2 includes the foreign body 8 or the defect 7, respectively. On the basis of the signal, a switch can be controlled, for example, to discharge the respective container 2, after the inspection, for another cleaning or recycling.

In FIGS. 6A-6B, a detailed view of a further embodiment of the illumination unit 3 of FIG. 2 is represented, wherein the light is emitted from the emission locations 31 to 42 of the light-emitting surface 30 each with temporally different intensity progresses.

In FIG. 6A, one can see that the emission location 33 emits light with a sinusoidal intensity progress 50 which includes a time offset P1=0 with respect to a time reference or a reference signal. In contrast, the intensity progress of the emission location 39 also extends sinusoidally, however, it has a different time offset P2 compared to the time reference or the reference signal. The intensity progresses of the two emission locations 33, 39 are here only indicated by way of example. All other emission locations 31, 32, 34 to 38, 40 to 42 also have a sinusoidal intensity progress, however, with different time offsets each. This corresponds to a respective different phase of the sinusoidal temporal variation, so that the light emitted from the light-emitting surface 30 is locally encoded on the basis of the phase characteristic.

In order to capture the different phases or time offsets of the different emission locations 31 to 42 in a camera image, the camera 4 shows transit time differences of the light transmitted via the containers 2 in order to determine the phase characteristic each for the image points of the camera image. In other words, the camera 4 is here embodied as a transit-time camera. It is conceivable that the camera captures the time offset with respect to the time reference or the reference signal each for the image points. This time offset then corresponds to the location information which is then, as represented above, analyzed with the image processing unit 6 in order to differentiate the defects 7 from the foreign bodies 8.

In contrast, one can see in FIG. 6B that the light is emitted from the emission locations 31 to 42 of the light-emitting surface 30 each with different intensity progresses 52, 53, wherein the intensity progresses 52, 53 each have different sequences of intensity steps I1 to I6 or I7 to I12, respectively. For example, the first intensity progress 52 alternatingly has two bright and two dark intensity steps I1 to I6. In contrast, the second intensity progress 53 alternatingly has one bright and one dark intensity step I7 to I12. The intensity progresses 52, 53 of the emission locations 33 and 39 are here pointed out only by way of example. In other words, the different emission locations 31 to 42 each emit different time sequences of intensity steps, so that these are encoded on the basis of the intensity characteristic.

The different intensity progresses 52, 53 are captured by means of the camera 4 in a sequence of camera images and analyzed as location information of the emission locations 31 to 42 with the image processing unit 6 to differentiate the defects 7 from the foreign bodies 8.

By analogy to FIGS. 5A-5C, after the analyzes, the second local region 7′ has an intensity progress deviating from the surrounding area U2 (or a plurality of deviating intensity progresses) which corresponds to a different location information, and thus, one can conclude that the defect 7 is present.

By the illumination unit 3 in the exemplified embodiments in FIGS. 1-6B being embodied to emit the light emitted from the light-emitting surface 30 on the basis of the polarization characteristic, the intensity characteristic, and/or the phase characteristic in a locally encoded manner, and by the camera 4 being embodied to capture the locally encoded light, it can be determined for the image points of the camera image, independent of the emission characteristic of the light-emitting surface 30, from which one of the emission locations 31 to 42 the corresponding light proportion originates. By the image processing unit 6 being embodied to analyze the at least one camera image for local information of the emission locations 31 to 42, a differentiation can be made, for example, between a defect and a foreign body due to a local modification of the emission location 33, 38. Vice versa, the intensity information can still be analyzed to be able to identify the absorption of the light by foreign bodies 7 particularly well with a diffuse emission characteristic. Consequently, with the method 100 or the device 1 according to the disclosure, it is possible to identify both foreign bodies 7 and defects 8 equally well with one single inspection unit 10. By this being done with one single inspection unit 10, a smaller installation space is required for this.

It will be understood that features mentioned in the above-described exemplified embodiments are not restricted to this combination of features and are also possible individually or in any other combinations.

1. A method for optically inspecting containers, wherein the containers are transported to an inspection unit with an illumination unit and with a camera, wherein the illumination unit emits light from a flat light-emitting surface, wherein the light is transmitted or reflected via the containers, wherein the camera captures at least one of the containers and the light transmitted or reflected via the same each in at least one camera image, and wherein the at least one camera image is analyzed by an image processing unit for intensity information in order to identify foreign bodies and/or defects in the containers,
wherein
the light emitted from the light-emitting surface is locally encoded on the basis of a polarization characteristic, an intensity characteristic and/or a phase characteristic and is captured by the camera in such a way that in the at least one camera image, different emission locations of the light-emitting surface can be differentiated from one another, and
the image processing unit analyzes the at least one camera image for location information of the emission locations in order to differentiate the defects from the foreign bodies.

2. The method according to claim 1, wherein the light is emitted from the light-emitting surface with the polarization characteristic, the intensity characteristic, and/or the phase characteristic in a locally varying manner, so that the different emission locations with the polarization characteristic, the intensity characteristic, and/or the phase characteristic are each encoded differently, and wherein the camera captures, in the at least one camera image, the polarization characteristic, the intensity characteristic, and/or the phase characteristic as the location information.

3. The method according to claim 1, wherein the image processing unit analyzes the at least one camera image for a first local region with intensity information deviating from a surrounding area in order to conclude that a foreign body is present.

4. The method according to claim 1, wherein the image processing unit analyzes the at least one camera image for a second local region with location information deviating from a surrounding area in order to conclude that a defect is present.

5. The method according to claim 1, wherein the at least one camera image with the image processing unit is separated into an intensity channel and a light characteristic channel for the polarization characteristic, the intensity characteristic, and/or the phase characteristic, and wherein the image processing unit identifies the foreign bodies on the basis of the intensity channel, and the defects on the basis of the light characteristic channel.

6. The method according to claim 1, wherein the light is emitted from the emission locations of the light-emitting surface each with temporally different intensity progresses to encode the different emission locations as the intensity characteristic and/or the phase characteristic.

7. The method according to claim 6, wherein the phase characteristic comprises a different time offset of the intensity progress each different for the different emission locations.

8. The method according to claim 7, wherein the intensity characteristic comprises different time sequences of light intensities of the intensity progress each different for the different emission locations.

9. The method according to claim 6, wherein the camera captures transit time differences of the light transmitted or reflected via the containers in order to determine the phase characteristic.

10. A device for optically inspecting containers comprising
an inspection unit with an illumination unit and with a camera,
an image processing unit for processing at least one camera image of the camera,
a transporter for transporting the containers to the inspection unit,
wherein the illumination unit is embodied to emit light with a flat light-emitting surface in order to illuminate the containers and/or transmit light through them,
wherein the camera is arranged at the inspection unit such that it captures in each case at least one of the containers and light transmitted or reflected via them in the at least one camera image,
wherein the image processing unit is embodied to analyze the at least one camera image for intensity information in order to identify foreign bodies and/or defects of the containers,
wherein
the illumination unit is embodied to emit the light from the light-emitting surface on the basis of a polarization characteristic, an intensity characteristic, and/or a phase characteristic in a locally encoded manner,
the camera is embodied to capture the locally encoded light, so that in the at least one camera image, different emission locations of the light-emitting surface can be differentiated from one another, and
the image processing unit is embodied to analyze the at least one camera image for location information of the emission locations in order to differentiate the defects from the foreign bodies.

11. The device according to claim 10, wherein the camera is embodied to capture the polarization characteristic, the intensity characteristic, and/or the phase characteristic in a spatially resolved manner.

12. The device according to claim 10, wherein the illumination unit is embodied to emit the light from the emission locations of the light-emitting surface each with temporally different intensity progresses in order to encode the different emission locations as the intensity characteristic and/or the phase characteristic.

13. The device according to claim 10, wherein the camera is embodied as a polarization camera and/or a transit-time camera.
